(19) United States
(12) Patent Application Publication
(10) Pub. No.: US 2026/0253787 A1
(43) Pub. Date: Aug. 27, 2026

(54) COIL COMPONENT

(71) Applicant: TDK Corporation, Tokyo (JP)

(72) Inventors: Takeshi OKUMURA, Tokyo (JP); Shuki WATANABE, Tokyo (JP); Hidenori TSUTSUI, Tokyo (JP); Hibiki MIYASAKA, Tokyo (JP); Kouji KAWAMURA, Tokyo (JP); Shohei IWAMA, Tokyo (JP)

(73) Assignee: TDK Corporation, Tokyo (JP)

(21) Appl. No.: 19/546,590

(22) Filed: Feb. 23, 2026

(30) Foreign Application Priority Data
Feb. 27, 2025 (JP) 2025-030065

(51) Int. Cl. H01F 27/28; H01F 27/29; H01F 27/32

(52) U.S. Cl. CPC H01F 27/2804; H01F 27/292; H01F 27/323; H01F 2027/2809

(57) ABSTRACT

Disclosed herein is a coil component that includes: first, second, third, and fourth coil patterns formed in a first conductor layer; a first terminal electrode connected in common to outer peripheral ends of the first and fourth coil patterns; second and third terminal electrodes respectively connected to outer peripheral ends of the second and third coil patterns; a fourth terminal electrode connected in common to inner peripheral ends of the first and fourth coil patterns; and fifth and sixth terminal electrodes respectively connected to inner peripheral ends of the second and third coil patterns. The second and third coil patterns are wound so as to be radially sandwiched between the first coil pattern and the fourth coil pattern. A pattern width of each of the first and fourth coil patterns is smaller than a pattern width of each of the second and third coil patterns.

### CROSS-REFERENCE TO RELATED APPLICATION

This application claims the benefit of Japanese Patent Application No. 2025-030065, filed on Feb. 27, 2025, the entire disclosure of which is incorporated by reference herein.

### BACKGROUND OF THE ART

### Field of the Art

The present disclosure relates to a coil component and, more particularly, to a coil component in which three coils are magnetically coupled to one another.

### Description of Related Art

General common-mode filters are coil components in which two coils are magnetically coupled to each other, and are widely used to eliminate common-mode noise superimposed to differential transmission lines. In recent years, transmission lines including three lines as one set have sometimes been used, thereby requiring a coil component in which the three lines are magnetically coupled to one another to eliminate common-mode noise superimposed on such transmission lines.

As the coil component in which three coils are magnetically coupled to one another, coil components described in Japanese Patent Nos. 7,053,535, 6,879,275, and 7,378,015 are known.

In the coil components described in Japanese Patent Nos. 7,053,535, 6,879,275, and 7,378,015, three coils are disposed in mutually different conductor layers, so that the thickness in the coil stacking direction tends to increase.

### SUMMARY

A coil component according to an aspect of the present disclosure includes: a plurality of conductor layers including at least a first conductor layer; first, second, third, and fourth coil patterns formed in the first conductor layer; a first terminal electrode connected in common to the outer peripheral ends of the first and fourth coil patterns; second and third terminal electrodes respectively connected to the outer peripheral ends of the second and third coil patterns; a fourth terminal electrode connected in common to the inner peripheral ends of the first and fourth coil patterns; and fifth and sixth terminal electrodes respectively connected to the inner peripheral ends of the second and third coil patterns, wherein the second and third coil patterns are wound so as to be radially sandwiched between the first coil pattern and the fourth coil pattern, and the pattern width of each of the first and fourth coil patterns is smaller than the pattern width of each of the second and third coil patterns.

### BRIEF DESCRIPTION OF THE DRAWINGS

The above features and advantages of the present disclosure will be more apparent from the following description of some embodiments taken in conjunction with the accompanying drawings, in which:

FIG. 1 is a schematic perspective view illustrating the external appearance of a coil component 1 according to an embodiment of the present disclosure in an orientation inverted with respect to the mounted state;

FIG. 2 is a partial cross-sectional view for explaining the structure of the coil layer 3;

FIG. 3 is a plan view illustrating the pattern shapes of conductor patterns located in the conductor layer M1;

FIG. 4 is a plan view illustrating the positions of vias formed in the insulating layer 12;

FIG. 5 is a plan view illustrating the pattern shapes of conductor patterns located in the conductor layer M3;

FIG. 6 is a plan view illustrating the positions of vias formed in the insulating layer 13;

FIG. 7 is a plan view illustrating the pattern shapes of conductor patterns located in the conductor layer M2;

FIG. 8 is a plan view illustrating the positions of vias formed in the insulating layer 14;

FIG. 9 is a plan view illustrating the pattern shapes of the terminal electrodes 101 to 106;

FIG. 10 is an equivalent circuit diagram of the coil component 1; and

FIG. 11 is a schematic plan view for explaining the pattern shape of a circuit board 5 on which the coil component 1 is mounted.

### DETAILED DESCRIPTION OF THE EMBODIMENTS

The present disclosure describes a technology applied to a coil component in which three coils are magnetically coupled to one another, for reducing the thickness in the coil stacking direction.

Some embodiments of the present disclosure will be explained below in detail with reference to the accompanying drawings.

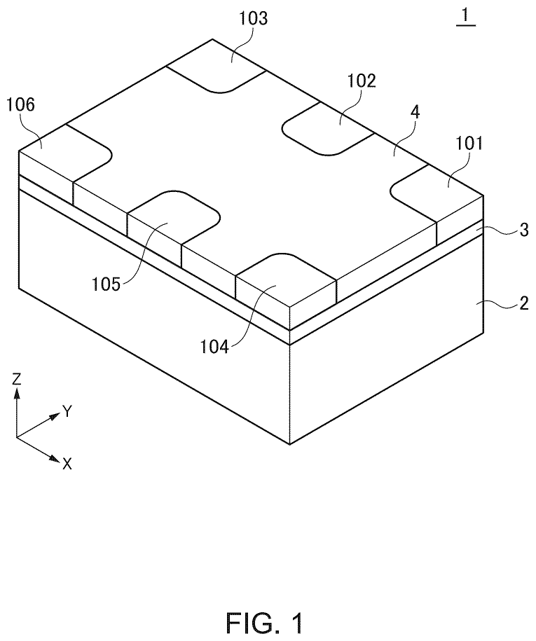

FIG. 1 is a schematic perspective view illustrating the external appearance of a coil component 1 according to an embodiment of the present disclosure in an orientation inverted with respect to the mounted state.

As illustrated in FIG. 1, the coil component 1 according to the present embodiment is a surface-mount type common-mode filter having a rectangular parallelepiped shape and includes a substrate 2, a coil layer 3 provided on the substrate 2, a resin layer 4 covering the coil layer 3, and six terminal electrodes 101 to 106 connected to the coil layer 3. The substrate 2 is made of a magnetic material such as ferrite or a nonmagnetic material and acts to support the coil layer 3, and provide sufficient mechanical strength to the coil component 1. When the substrate 2 is made of a magnetic material, it also serves as a magnetic path for a magnetic field generated by the coil layer 3. The resin layer 4 may also be made of a magnetic material or a nonmagnetic material. When the resin layer 4 is made of a magnetic material, such as a composite material obtained by dispersing magnetic powder composed of a metallic magnetic substance in a binder resin, it serves as a magnetic path for a magnetic field generated by the coil layer 3. The resin layer 4 may be omitted. The terminal electrodes 101 to 106 are disposed at the corners or edges of the coil component 1 and are embedded in the resin layer 4 such that their upper and side surfaces are exposed.

The terminal electrodes 101 to 103 are arranged along one long side extending in the X-direction, and the terminal electrodes 104 to 106 are arranged along the other long side extending in the X-direction. Although not particularly limited, the terminal electrodes 101, 103, 104, and 106 are disposed at the corners of the coil component 1, and are therefore exposed on three surfaces (XY, XZ, and YZ surfaces) of the coil component 1. On the other hand, the remaining terminal electrodes 102 and 105 are exposed on two surfaces (XY and XZ surfaces) of the coil component 1. Although not particularly limited, the terminal electrodes 101 to 106 are formed by a thick plating method, and their thicknesses are significantly larger than that of an electrode pattern formed by sputtering or screen printing.

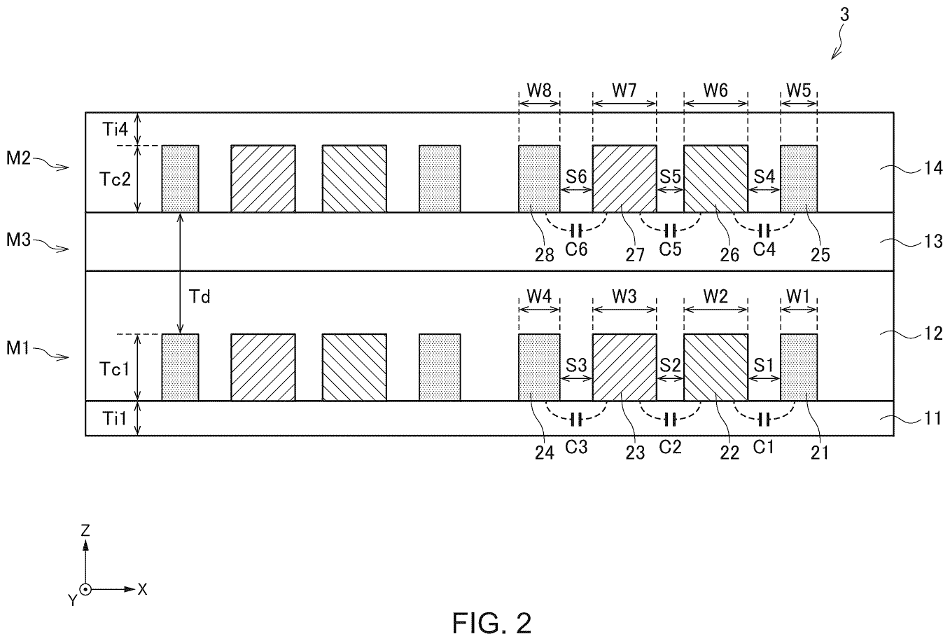

FIG. 2 is a partial cross-sectional view for explaining the structure of the coil layer 3.

As illustrated in FIG. 2, the coil layer 3 includes insulating layers 11 to 14 stacked in the Z-direction, a conductor layer M1 located between the insulating layers 11 and 12 so as to be embedded in the insulating layer 12, a conductor layer M2 located between the insulating layers 13 and 14 so as to be embedded in the insulating layer 14, and a conductor layer M3 located between the insulating layers 12 and 13 so as to be embedded in the insulating layer 13. In the example illustrated in FIG. 2, the conductor layers M1, M3, and M2 are stacked in this order. That is, the conductor layer M3 is located between the conductor layers M1 and M2. Each of the conductor layers M1 to M3 includes a plurality of conductor patterns; however, the conductor patterns located in the conductor layer M3 are not illustrated in the cross-sectional view of FIG. 2. The insulating layers 11 to 14 are made of an insulating material such as resin. The conductor patterns provided in the conductor layers M1 to M3 are made of a good conductor such as copper (Cu).

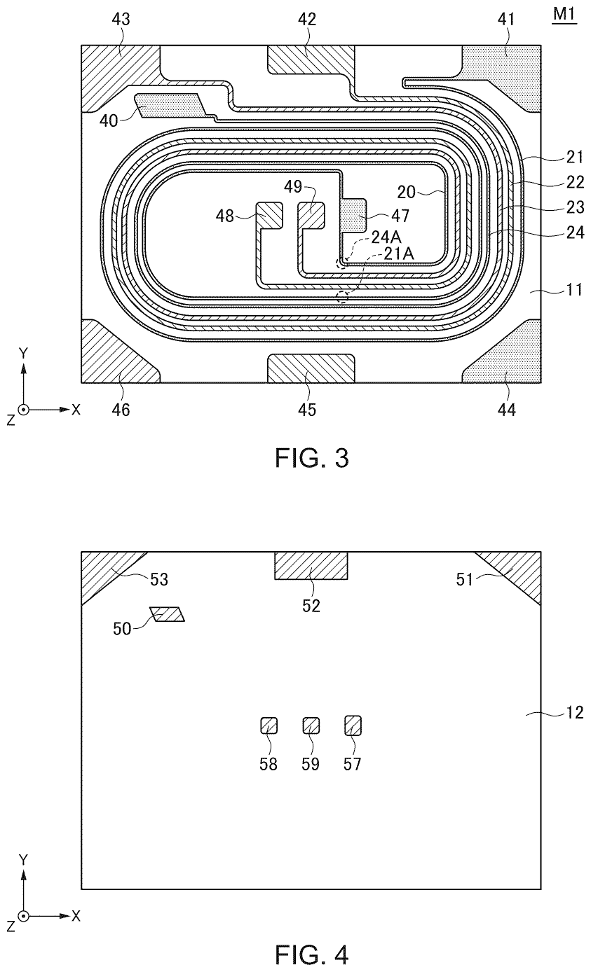

FIG. 3 is a plan view illustrating the pattern shapes of conductor patterns located in the conductor layer M1.

As illustrated in FIG. 3, the conductor layer M1 includes coil patterns 21 to 24 each wound in a spiral shape and terminal patterns 40 to 49. Each of the coil patterns 21 to 24 has approximately 1.5 turns. In the same turn, the coil pattern 21 is located at the outermost periphery, the coil pattern 22 is located at the second outermost periphery, the coil pattern 23 is located at the third outermost periphery, and the coil pattern 24 is located at the innermost periphery. That is, the coil patterns 22 and 23 are radially located between the coil patterns 21 and 24.

The outer peripheral ends of the coil patterns 21 to 23 are connected to the terminal patterns 41 to 43, respectively. The terminal patterns 41 to 43 are arranged in this order in the X-direction. That is, the terminal pattern 42 is located between the terminal patterns 41 and 43. The terminal patterns 41 to 43 may be exposed at the edge of the conductor layer M1. The outer peripheral end of the coil pattern 24 is connected to the terminal pattern 40. The inner peripheral ends of the coil patterns 21 and 24 are connected in common to the terminal pattern 47. The inner peripheral ends of the coil patterns 22 and 23 are connected to the terminal patterns 48 and 49, respectively. The terminal patterns 47, 49, and 48 are arranged in this order in the X-direction. That is, the terminal pattern 49 is located between the terminal patterns 47 and 48. The terminal patterns 44 to 46 are independently provided on the same surface and are not connected to other conductor patterns. The terminal patterns 44 to 46 are arranged in this order in the X-direction. The terminal patterns 44 to 46 may be exposed at the edge of the conductor layer M1.

FIG. 4 is a plan view illustrating the positions of vias formed in the insulating layer 12.

As illustrated in FIG. 4, vias 50 to 53 and 57 to 59 are formed in the insulating layer 12 so as to expose the conductor layer M1. The vias 50 to 53 and 57 to 59 are formed to expose the terminal patterns 40 to 43 and 47 to 49, respectively.

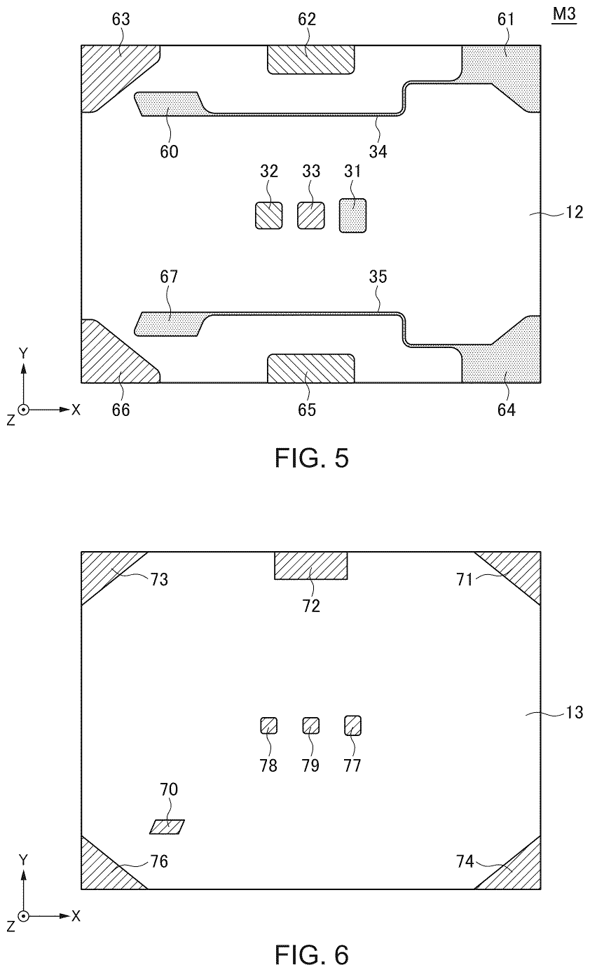

FIG. 5 is a plan view illustrating the pattern shapes of conductor patterns located in the conductor layer M3.

As illustrated in FIG. 5, the conductor layer M3 includes connection patterns 31 to 35 and terminal patterns 60 to 67. The connection patterns 31 to 33 are respectively connected to the terminal patterns 47 to 49 located in the conductor layer M1 through the vias 57 to 59 formed in the insulating layer 12. The connection pattern 34 connects the terminal patterns 60 and 61. The connection pattern 35 connects the terminal patterns 64 and 67. The terminal pattern 60 is connected to the terminal pattern 40 located in the conductor layer M1 through the via 50 formed in the insulating layer 12. The terminal patterns 61 to 63 are respectively connected to the terminal patterns 41 to 43 located in the conductor layer M1 through the vias 51 to 53 formed in the insulating layer 12. As a result, the outer peripheral end of the coil pattern 21 and the outer peripheral end of the coil pattern 24 are connected to each other through the connection pattern 34. The terminal patterns 61 to 66 may be exposed at the edge of the conductor layer M2.

FIG. 6 is a plan view illustrating the positions of vias formed in the insulating layer 13.

As illustrated in FIG. 6, vias 70 to 74 and 76 to 79 are formed in the insulating layer 13 so as to expose the conductor layer M2. The vias 71 to 74 and 76 are formed to expose the terminal patterns 61 to 64 and 66, respectively. The via 70 is formed to expose the terminal pattern 67. The vias 77 to 79 are formed to expose the connection patterns 31 to 33, respectively.

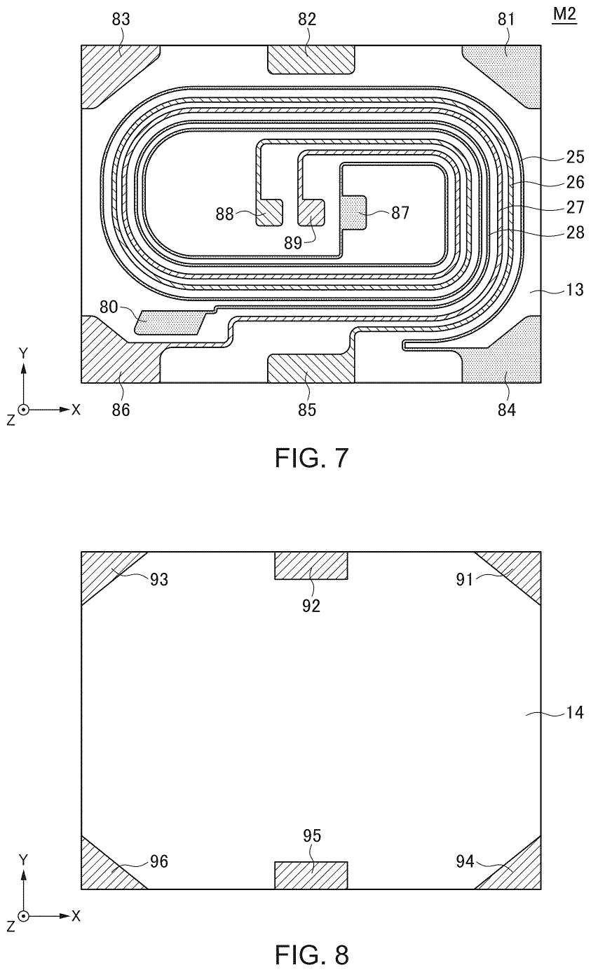

FIG. 7 is a plan view illustrating the pattern shapes of conductor patterns located in the conductor layer M2.

As illustrated in FIG. 7, the conductor layer M2 includes coil patterns 25 to 28 each wound in a spiral shape and terminal patterns 80 to 89. Each of the coil patterns 25 to 28 has approximately 1.5 turns. In the same turn, the coil pattern 25 is located at the outermost periphery, the coil pattern 26 is located at the second outermost periphery, the coil pattern 27 is located at the third outermost periphery, and the coil pattern 28 is located at the innermost periphery. That is, the coil patterns 26 and 27 are radially located between the coil patterns 25 and 28.

The outer peripheral ends of the coil patterns 25 to 27 are connected to the terminal patterns 84 to 86, respectively. The terminal patterns 84 to 86 are arranged in this order in the X-direction. That is, the terminal pattern 85 is located between the terminal patterns 84 and 86. The terminal patterns 84 to 86 may be exposed at the edge of the conductor layer M2. The outer peripheral end of the coil pattern 28 is connected to the terminal pattern 80. The inner peripheral ends of the coil patterns 25 and 28 are connected in common to the terminal pattern 87. The inner peripheral ends of the coil patterns 26 and 27 are connected to the terminal patterns 88 and 89, respectively. The terminal patterns 87, 89, and 88 are arranged in this order in the X-direction. That is, the terminal pattern 89 is located between the terminal patterns 87 and 88. The terminal patterns 81 to 83 are independently provided on the same surface and are not connected to other conductor patterns. The terminal patterns 81 to 83 are arranged in this order in the X-direction. The terminal patterns 81 to 83 may be exposed at the edge of the conductor layer M2.

The terminal patterns 81 to 84 and 86 are respectively connected to the terminal patterns 61 to 64 and 66 located in the conductor layer M3 through the vias 71 to 74 and 76 formed in the insulating layer 13. The terminal pattern 80 is connected to the terminal pattern 67 located in the conductor layer M3 through the via 70 formed in the insulating layer 13. The terminal patterns 87 to 89 are respectively connected to the connection patterns 31 to 33 located in the conductor layer M3 through the vias 77 to 79 formed in the insulating layer 13. As a result, the outer peripheral end of the coil pattern 25 and the outer peripheral end of the coil pattern 28 are connected to each other through the connection pattern 35. Further, the inner peripheral ends of the coil patterns 21, 24 and the inner peripheral ends of the coil patterns 25, 28 are connected to each other through the connection pattern 31, the inner peripheral end of the coil pattern 22 and the inner peripheral end of the coil pattern 26 are connected to each other through the connection pattern 32, and the inner peripheral end of the coil pattern 23 and the inner peripheral end of the coil pattern 27 are connected to each other through the connection pattern 33.

FIG. 8 is a plan view illustrating the positions of vias formed in the insulating layer 14.

As illustrated in FIG. 8, vias 91 to 96 are formed in the insulating layer 14 so as to expose the conductor layer M2. The vias 91 to 96 are formed to expose the terminal patterns 81 to 86, respectively.

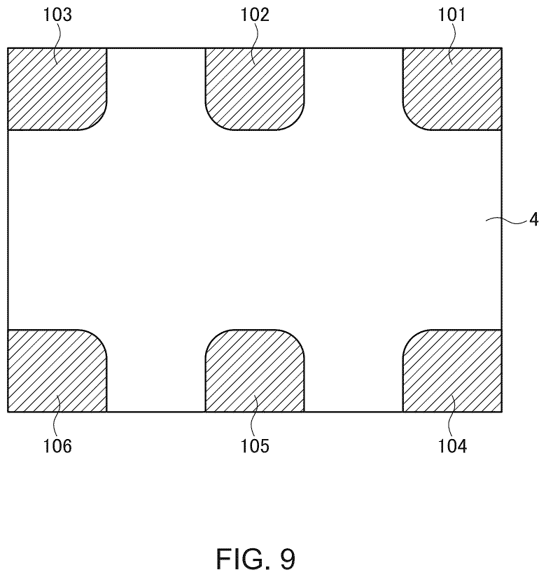

FIG. 9 is a plan view illustrating the pattern shapes of the terminal electrodes 101 to 106.

The terminal electrodes 101 to 106 illustrated in FIG. 9 are respectively connected to the terminal patterns 81 to 86 located in the conductor layer M2 through the vias 91 to 96 formed in the insulating layer 14. As a result, the coil patterns 21 and 24 are connected in parallel between the terminal electrode 101 and the connection pattern 31, and the coil patterns 25 and 28 are connected in parallel between the terminal electrode 104 and the connection pattern 31. Further, the coil pattern 22 is connected between the terminal electrode 102 and the connection pattern 32, and the coil pattern 26 is connected between the terminal electrode 105 and the connection pattern 32. Further, the coil pattern 23 is connected between the terminal electrode 103 and the connection pattern 33, and the coil pattern 27 is connected between the terminal electrode 106 and the connection pattern 33.

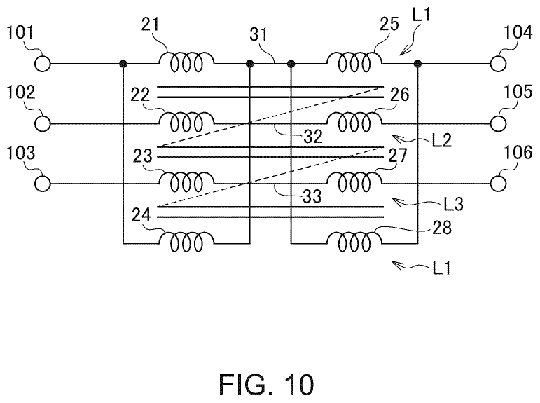

FIG. 10 is an equivalent circuit diagram of the coil component 1 according to the present embodiment.

As illustrated in FIG. 10, the parallel-connected coil patterns 21, 24 and the parallel-connected coil patterns 25, 28 are connected in series through the connection pattern 31, thereby forming an inductor L1. The coil patterns 22 and 26 are connected in series between the terminal electrodes 102 and 105 through the connection pattern 32, thereby forming an inductor L2. The coil patterns 23 and 27 are connected in series between the terminal electrodes 103 and 106 through the connection pattern 33, thereby forming an inductor L3. Each of the inductors L1 to L3 has approximately 3 turns. The coil component 1 according to the present embodiment constitutes a three-line common-mode filter in which the three inductors L1 to L3 are magnetically coupled to one another.

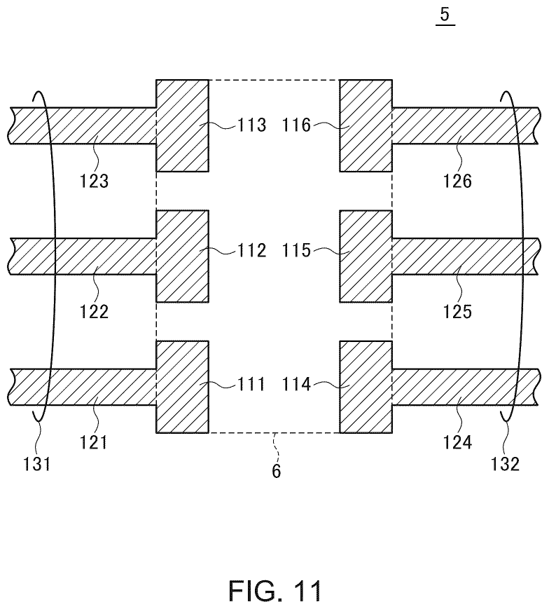

FIG. 11 is a schematic plan view for explaining the pattern shape of a circuit board 5 on which the coil component 1 is mounted.

The circuit board 5 illustrated in FIG. 11 has a mounting area 6 on which the coil component 1 is mounted. The mounting area 6 is provided with land patterns 111 to 116 corresponding to the terminal electrodes 101 to 106, respectively. When the coil component 1 is mounted on the mounting area 6, the terminal electrodes 101 to 106 are electrically connected to their corresponding land patterns 111 to 116.

Signal lines 121 to 126 are connected to the land patterns 111 to 116, respectively, on the circuit board 5. The signal lines 121 to 123 form one line group 131, while the signal lines 124 to 126 form another line group 132. For example, the line group 131 serves as an input-side line group, while the line group 132 serves as an output-side line group. Three signals transmitted by each of the line groups 131 and 132 represent data using the potential difference between two of the signals. For example, in the line group 131, data is represented by the relative level difference between the signal lines 121 and 122, by the relative level difference between the signal lines 121 and 123, and by the relative level difference between the signal lines 122 and 123. The same applies to the line group 132. This allows 3-bit data to be transmitted simultaneously in this example. By inserting the coil component 1 according to the present embodiment between the thus configured line groups 131 and 132, common-mode noise superimposed on three signals can be eliminated.

As illustrated in FIG. 2, the coil patterns 21 and 22 are adjacent to each other through the insulating layer 12, the coil patterns 22 and 23 are adjacent to each other through the insulating layer 12, and the coil patterns 23 and 24 are adjacent to each other through the insulating layer 12. As a result, a stray capacitance C1 is generated between the coil pattern 21 and 22, a stray capacitance C2 is generated between the coil pattern 22 and 23, and a stray capacitance C3 is generated between the coil pattern 23 and 24. Thus, assuming that a space S1 between the coil patterns 21 and 22, a space S2 between the coil patterns 22 and 23, and a space S3 between the coil patterns 23 and 24 are substantially the same, the stray capacitances C1 to C3 are also substantially the same. Since the coil patterns 21 and 24 form a single coil in which the inner and outer peripheral ends are electrically shorted, capacitive components generated between the coil formed by the coil patterns 21 and 24, the coil formed by the coil pattern 22, and the coil formed by the coil pattern 23 are substantially the same.

Similarly, the coil patterns 25 and 26 are adjacent to each other through the insulating layer 14, the coil patterns 26 and 27 are adjacent to each other through the insulating layer 14, and the coil patterns 27 and 28 are adjacent to each other through the insulating layer 14. As a result, a stray capacitance C4 is generated between the coil pattern 25 and 26, a stray capacitance C5 is generated between the coil pattern 26 and 27, and a stray capacitance C6 is generated between the coil pattern 27 and 28. Thus, assuming that a space S4 between the coil patterns 25 and 26, a space S5 between the coil patterns 26 and 27, and a space S6 between the coil patterns 27 and 28 are substantially the same, the stray capacitances C4 to C6 are also substantially the same. Since the coil patterns 25 and 28 form a single coil in which the inner and outer peripheral ends are electrically shorted, capacitive components generated between the coil formed by the coil patterns 25 and 28, the coil formed by the coil pattern 26, and the coil formed by the coil pattern 27 are substantially the same.

Assuming that the radial pattern widths of the coil patterns 21 to 24 are defined as W1 to W4, respectively, the pattern widths W1 and W4 are smaller than the pattern widths W2 and W3. This reduces the difference in DC resistance among the coil formed by the coil patterns 21 and 24, the coil formed by the coil pattern 22, and the coil formed by the coil pattern 23. The pattern widths W1 and W4 may be the same. The pattern widths W2 and W3 may be the same. Setting the pattern widths W1 and W4 to approximately half the pattern widths W2 and W3 further reduces the difference in DC resistance among the coil formed by the coil patterns 21 and 24, the coil formed by the coil pattern 22, and the coil formed by the coil pattern 23. Further, setting the pattern width W1 of the coil pattern 21 located on the outer peripheral side larger than the pattern width W4 of the coil pattern 24 located on the inner peripheral side can also reduce the difference in DC resistance resulting from the difference in line length between the coil patterns 21 and 24. From the same reason, setting the pattern width W2 of the coil pattern 22 located on the outer peripheral side larger than the pattern width W3 of the coil pattern 23 located on the inner peripheral side can also reduce the difference in DC resistance resulting from the difference in line length between the coil patterns 22 and 23.

Similarly, assuming that the radial pattern widths of the coil patterns 25 to 28 are defined as W5 to W8, respectively, the pattern widths W5 and W8 are smaller than the pattern widths W6 and W7. This reduces the difference in DC resistance among the coil formed by the coil patterns 25 and 28, the coil formed by the coil pattern 26, and the coil formed by the coil pattern 27. The pattern widths W5 and W8 may be the same. The pattern widths W6 and W7 may be the same. Setting the pattern widths W5 and W8 to approximately half the pattern widths W6 and W7 further reduces the difference in DC resistance among the coil formed by the coil patterns 25 and 28, the coil formed by the coil pattern 26, and the coil formed by the coil pattern 27. Further, setting the pattern width W5 of the coil pattern 25 located on the outer peripheral side larger than the pattern width W8 of the coil pattern 28 located on the inner peripheral side can also reduce the difference in DC resistance resulting from the difference in line length between the coil patterns 25 and 28. From the same reason, setting the pattern width W6 of the coil pattern 26 located on the outer peripheral side larger than the pattern width W7 of the coil pattern 27 located on the inner peripheral side can also reduce the difference in DC resistance resulting from the difference in line length between the coil patterns 26 and 27.

The pattern widths W1 and W5 may be the same. The pattern widths W2 and W6 may be the same. The pattern widths W3 and W7 may be the same. The pattern widths W4 and W8 may be the same. The spaces S1 to S6 may be the same.

As illustrated in FIG. 2, a distance Td between the conductor layers M1 and M2 in the Z-direction (stacking direction) may be larger than either one or both of film thicknesses Ti1 and Ti4 of the insulating layers 11 and 14. The film thickness Ti4 of the insulating layer 14 is defined as the distance between the upper end surface of the conductor layer M2 and the surface of the insulating layer 14 in the Z-direction. Setting the distance Td between the conductor layers M1 and M2 greater than either one or both of the film thicknesses Ti1 and Ti4 of the insulating layers 11 and 14 reduces the stray capacitance generated between the conductor layers M1 and M2, thereby enhancing high-frequency characteristics. The film thickness Ti1 of the lowermost insulating layer 11 serving as a base for the conductor layer M1 and the film thickness Ti4 of the uppermost insulating layer 14 do not have a direct influence on the stray capacitance generated between the conductor layers M1 and M2; however, reducing the film thicknesses Ti1 and Ti4 decreases the overall thickness of the coil component 1 in the Z-direction and enhances magnetic characteristics.

The distance Td between the conductor layers M1 and M2 may be greater than the total of the film thicknesses Ti1 and Ti4. This sufficiently ensures the distance Td between the conductor layers M1 and M2, thereby further reducing the stray capacitance generated between the conductor layers M1 and M2. Further, the distance Td between the conductor layers M1 and M2 may be greater than a conductor thickness Tc1 of the conductor layer M1 or a conductor thickness Tc2 of the conductor layer M2. An increase in the conductor thicknesses Tc1 and Tc2 of the conductor layers M1 and M2 increases the stray capacitances C1 to C6, so that by setting the conductor thicknesses Tc1 and Tc2 smaller than the distance Td between the conductor layers M1 and M2, the stray capacitances C1 to C6 can be reduced.

The line length balance between the coil patterns 21 and 24 and that between the coil patterns 25 and 28 can be adjusted also by the position of the connection pattern 31 (positions of the terminal patterns 47 and 87). As illustrated in FIG. 3, the terminal pattern 47 (connection pattern 31) is disposed on a portion of a section 20 that connects a position 21A, which is located approximately 1.5 turns from the outer peripheral end of the coil pattern 21, and a position 24A, which is located approximately 1.5 turns from the outer peripheral end of the coil pattern 24. In the example illustrated in FIG. 3, the terminal pattern 47 is disposed on a portion of section 20 closer to the position 24A, so that the line length between the terminal pattern 47 and the position 21A is longer than that between the terminal pattern 47 and the position 24A. Furthermore, by arranging the terminal patterns 47, 49, and 48 in this order, the winding direction of the section 20 coincides with that of coil patterns 21 and 24, thereby increasing inductance.

As described above, in the present embodiment, one of the three coils is divided into two coil patterns, which sandwich the remaining two coils, so that the difference in stray capacitance among the three coils is reduced. In addition, the three coils (i.e., four coil patterns) are disposed in a single conductor layer, making it possible to reduce the overall thickness.

While some embodiments of the technology according to the present disclosure have been described, the technology according to the present disclosure is not limited to the above embodiments, and various modifications may be made within the scope of the present disclosure, and all such modifications are included in the technology according to the present disclosure.

The technology according to the present disclosure includes the following configuration examples, but not limited thereto.

A coil component according to an aspect of the present disclosure includes: a plurality of conductor layers including at least a first conductor layer; first, second, third, and fourth coil patterns formed in the first conductor layer; a first terminal electrode connected in common to the outer peripheral ends of the first and fourth coil patterns; second and third terminal electrodes respectively connected to the outer peripheral ends of the second and third coil patterns; a fourth terminal electrode connected in common to the inner peripheral ends of the first and fourth coil patterns; and fifth and sixth terminal electrodes respectively connected to the inner peripheral ends of the second and third coil patterns, wherein the second and third coil patterns are wound so as to be radially sandwiched between the first coil pattern and the fourth coil pattern, and the pattern width of each of the first and fourth coil patterns is smaller than the pattern width of each of the second and third coil patterns. This reduces the difference in stray capacitance generated among a coil formed by the first and fourth coil pattern, a coil formed by the second coil pattern, and a coil formed by the third coil pattern.

In the above coil component, the second terminal electrode may be located between the first terminal electrode and the third terminal electrode, and the inner peripheral end of the third coil pattern may be located between the inner peripheral ends of the first and fourth coil patterns and the inner peripheral end of the second coil pattern. This increases the inductances of the first and fourth coil patterns.

The above coil component may further include fifth, sixth, seventh, and eighth coil patterns formed in a second conductor layer included in the plurality of conductor layers, the outer peripheral ends of the fifth and eighth coil patterns may be connected in common to the fourth terminal electrode, the outer peripheral ends of the sixth and seventh coil patterns may be respectively connected to fifth and sixth terminal electrodes, the inner peripheral ends of the first and fourth coil patterns may be connected in common to the inner peripheral ends of the fifth and eighth coil patterns, and the inner peripheral ends of the second and third coil patterns may be respectively connected to the inner peripheral ends of the sixth and seventh coil patterns. This increases the number of turns of the three coils, making it possible to achieve higher inductance.

The above coil component may further include first, second, and third connection patterns formed in a third conductor layer included in the plurality of conductor layers, the inner peripheral ends of the first and fourth coil patterns and the inner peripheral ends of the fifth and eighth coil patterns may be connected through the first connection pattern, the inner peripheral end of the second coil pattern and the inner peripheral end of the sixth coil pattern may be connected through the second connection pattern, and the inner peripheral end of the third coil pattern and the inner peripheral end of the seventh coil pattern may be connected through the third connection pattern. This facilitates connection between the first and second conductor layers.

The above coil component may further include fourth and fifth connection patterns formed in the third conductor layer, the outer peripheral end of the first coil pattern and the outer peripheral end of the fourth coil pattern may be connected through the fourth connection pattern, and the outer peripheral end of the fifth coil pattern and the outer peripheral end of the eighth coil pattern may be connected through the fifth connection pattern. This allows connections between the outer peripheral ends of the first and fourth coil patterns and between the outer peripheral ends of the fifth and eighth coil patterns without using a fourth conductor layer.

In the above coil component, the third conductor layer may be located between the first conductor layer and the second conductor layer. This can provide a sufficient distance between the first and second conductor layers.

The above coil component may further include a first insulating layer serving as a base for the first conductor layer, a second insulating layer located between the first conductor layer and the third conductor layer, a third insulating layer located between the third conductor layer and the second conductor layers, and a fourth insulating layer covering the third conductor layer, and the distance between the first conductor layer and the second conductor layer in the stacking direction may be greater than at least one of the film thicknesses of the first and fourth insulating layers. This makes it possible to reduce a capacitance component generated between the first and second conductor layers.

In the above coil component, the distance between the first conductor layer and the second conductor layer in the stacking direction may be greater than the total film thickness of the first and fourth insulating layers. This makes it possible to reduce a capacitance component generated between the first and second conductor layers.

In the above coil component, the distance between the first conductor layer and the second conductor layer in the stacking direction may be greater than at least one of the conductor thicknesses of the first and second conductor layers. This makes it possible to reduce the stray capacitance generated between the first to fourth coil patterns or between the fifth to eighth coil patterns.

What is claimed is:

1. A coil component comprising:
a plurality of conductor layers including at least a first conductor layer;
first, second, third, and fourth coil patterns formed in the first conductor layer;
a first terminal electrode connected in common to outer peripheral ends of the first and fourth coil patterns;
second and third terminal electrodes respectively connected to outer peripheral ends of the second and third coil patterns;
a fourth terminal electrode connected in common to inner peripheral ends of the first and fourth coil patterns; and
fifth and sixth terminal electrodes respectively connected to inner peripheral ends of the second and third coil patterns,
wherein the second and third coil patterns are wound so as to be radially sandwiched between the first coil pattern and the fourth coil pattern, and
wherein a pattern width of each of the first and fourth coil patterns is smaller than a pattern width of each of the second and third coil patterns.

2. The coil component as claimed in claim 1,
wherein the second terminal electrode is located between the first terminal electrode and the third terminal electrode, and
wherein the inner peripheral end of the third coil pattern is located between the inner peripheral ends of the first and fourth coil patterns and the inner peripheral end of the second coil pattern.

3. The coil component as claimed in claim 1, further comprising fifth, sixth, seventh, and eighth coil patterns formed in a second conductor layer included in the plurality of conductor layers,
wherein outer peripheral ends of the fifth and eighth coil patterns are connected in common to the fourth terminal electrode,
wherein outer peripheral ends of the sixth and seventh coil patterns are respectively connected to fifth and sixth terminal electrodes,
wherein the inner peripheral ends of the first and fourth coil patterns are connected in common to inner peripheral ends of the fifth and eighth coil patterns, and
wherein the inner peripheral ends of the second and third coil patterns are respectively connected to inner peripheral ends of the sixth and seventh coil patterns.

4. The coil component as claimed in claim 3, further comprising first, second, and third connection patterns formed in a third conductor layer included in the plurality of conductor layers,
wherein the inner peripheral ends of the first and fourth coil patterns and the inner peripheral ends of the fifth and eighth coil patterns are connected through the first connection pattern,
wherein the inner peripheral end of the second coil pattern and the inner peripheral end of the sixth coil pattern are connected through the second connection pattern, and
wherein the inner peripheral end of the third coil pattern and the inner peripheral end of the seventh coil pattern are connected through the third connection pattern.

5. The coil component as claimed in claim 4, further comprising fourth and fifth connection patterns formed in the third conductor layer,
wherein the outer peripheral end of the first coil pattern and the outer peripheral end of the fourth coil pattern are connected through the fourth connection pattern, and
wherein the outer peripheral end of the fifth coil pattern and the outer peripheral end of the eighth coil pattern are connected through the fifth connection pattern.

6. The coil component as claimed in claim 4, wherein the third conductor layer is located between the first conductor layer and the second conductor layer.

7. The coil component as claimed in claim 6, further comprising:
a first insulating layer serving as a base for the first conductor layer;
a second insulating layer located between the first conductor layer and the third conductor layer;
a third insulating layer located between the third conductor layer and the second conductor layer; and
a fourth insulating layer covering the third conductor layer,
wherein a distance between the first conductor layer and the second conductor layer in a stacking direction is greater than at least one of film thicknesses of the first and fourth insulating layers.

8. The coil component as claimed in claim 7, wherein the distance between the first conductor layer and the second conductor layer in the stacking direction is greater than a total film thickness of the first and fourth insulating layers.

9. The coil component as claimed in claim 7, wherein the distance between the first conductor layer and the second conductor layer in the stacking direction is greater than at least one of conductor thicknesses of the first and second conductor layers.
